(19) United States
(12) Patent Application Publication
(10) Pub. No.: US 2004/0103431 A1
(43) Pub. Date: May 27, 2004

(54) Method and system for emergency planning and management of a facility

(75) Inventors: H. Edward Davenport, Cranford, NJ (US); Andrew G. Flacks, Cranford, NJ (US)

Correspondence Address: Paul Teng, Cooper & Dunham LLP, 1185 Avenue of the Americas, New York, NY, 10036, US

(73) Assignee: Crisis Technologies, Inc.

(21) Appl. No.: 10/174,006

(22) Filed: Jun. 17, 2002

Related U.S. Application Data
(60) Provisional application No. 60/299,965, filed on Jun. 21, 2001.

(51) Int. Cl. G06F 17/60; H04N 7/025; H04N 7/10; H04M 11/04

(52) U.S. Cl. 725/33; 705/1; 379/45

(57) ABSTRACT

An apparatus and method for emergency planning and management of a facility is provided. A plurality of hyperlinks are integrated with an electronic plan of the facility. The hyperlinks are associated with respective electronic capture-and-display media, which provide visual representations of respective locations at the facility. One of the electronic capture-and display media is retrieved and played in a viewer, after a hyperlink associated with the retrieved media is selected. The retrieved media includes a focused view of a point of particular interest, from an expert point of view.

### CROSS-REFERENCE TO RELATED APPLICATION

This application claims the benefit of commonly-assigned provisional application No. 60/299,965, filed Jun. 21, 2001 and entitled “METHOD AND SYSTEM FOR EMERGENCY PLANNING AND MANAGEMENT OF A FACILITY”, which is incorporated herein in its entirety by reference.

### TECHNICAL FIELD

The present disclosure relates to preparing for emergencies. In particular, the disclosure relates to apparatus, systems and methods for emergency planning and management of a facility.

### DESCRIPTION OF RELATED ART

One of the prevalent concerns of the general public today is preparedness to handle emergencies, caused by, for example, terrorist attacks (e.g., World Trade Center attacks and Oklahoma City bombing), workplace or school violence (e.g., fourteen students and one teacher killed at Columbine High School), natural disasters (e.g., assorted hurricanes, tornados, earthquakes), industrial (e.g., nuclear plant meltdown) and other accidents (e.g., major fires and hazardous material release), etc.

In view of the many incidents of, in particular, violence in public in recent years, security and preventive measures have been taken to dampen the risks of terrorist attacks, school and workplace violence, and other violent incidents in public and/or publicly accessed facilities (as well as in many private facilities). Such measures include establishing policies, increasing awareness at large and consulting specialists who bring insight and historical knowledge to identify causes of, as well as preventive measures for, such emergencies.

Notwithstanding the measures taken, it appears that there is still a great need for improving preparedness for emergencies. For example, escalation of school violence has created the need for expanded school emergency preparedness and better-coordinated emergency response. Emergency response in recent years has been severely affected by issues of organization, coordination, and communication. In many instances, emergency operations are planned and undertaken “on the fly” at the site of the emergency, based on information which is limited in amount and questionable in accuracy. In the chaos surrounding a crisis, it may be too late to assemble, verify, and communicate vital information to responders to the emergency.

Coordination between responding agencies and providing emergency response persons with critical information are crucial factors for making strategic decisions and preventing further casualties and destruction. The initial period of an emergency, during which many strategic decisions must be made by the responding agencies, typically is very important for obtaining a favorable result.

Emergency response agencies and organizations (hereinafter, “first responder” or “emergency responder”) may include, for example, fire department, EMS, SWAT, HazMat, local/city police, the FBI, county sheriff and emergency management, state patrol, other law enforcement and support agencies, school districts, etc. Historically, there have not been close working relationships between first responder agencies until they are brought together for an emergency. In many instances, first responders do not know one another prior to meeting at the emergency site. In addition, many of the first responders may be from out of town, and therefore is approaching a site for the first time. Thus, the emergency response effort may be hindered by unfamiliarity of the team members with each other and with critical information regarding the facility. An opportunity to plan and prepare, from a common perspective amongst the various responding agencies, for a disaster, such as by (either actually or virtually) walking through the facility and identifying hazards, observation sites, and evacuation routes, would greatly enhance the effectiveness of emergency operations.

Key information needs of responders to an emergency at a facility typically include the following: detailed descriptive information about the facility, such as relevant contacts and utilities; maps and floor plans of the facility and surrounding area; emergency plans for communicating facility actions to responders; and any other predeveloped plans for managing an incident. Such information typically is scattered amongst various sources and storage locations.

For example, some fire departments may keep floor plans of local facilities on compact discs (CDS) or digital video discs (DVDs). Other agencies may have static web pages containing information/plans for responding to emergencies. Schools/facilities may have their emergency plans in their office files and/or computers.

However, there is a need to collect, coordinate and centralize information vitally needed by emergency personnel, and provide such information in a manner and form that is easy to access and use. Thus, emergency responders (from any responding agency or jurisdiction) can quickly review substantially all critical facility information, and thereby coordinate tactical actions between agencies and communicate status during a school emergency.

In addition, there is an unmet need for emergency planning and management tools which provide emergency responders with means to become familiar with a facility from an expert point of view, as if the responders have engaged in numerous exercises at the facility, without requiring the responders to have ever visited the facility.

### SUMMARY

The subject application provides an apparatus for emergency planning and management of a facility. The apparatus, according to one embodiment, includes an electronic plan of the facility and a plurality of electronic capture-and-display media. A plurality of hyperlinks are integrated with the electronic plan. The hyperlinks are associated with respective ones of the electronic capture-and-display media. The electronic capture-and-display media provide visual representations of respective locations at the facility. At least one of the electronic capture-and-display media, when retrieved and shown in a viewer, includes a focused view of a point of particular interest, from an expert point of view. According to a preferred embodiment, the electronic plan and the electronic capture-and-display media are presented from the expert point of view for briefing emergency workers. Each electronic capture-and-display medium which is associated with a hyperlink in the electronic plan may be selected when the electronic plan is displayed.

According to one embodiment, the retrieved electronic capture-and-display medium may include a motion video. The motion video may be pre-recorded and produced by a camera in a walk-through of a corresponding room. When the hyperlink corresponding to the motion video is selected, the motion video, according to one embodiment, is delivered to the viewer through a network as a video stream. The motion video may include a panoramic view of a corresponding room.

According to another embodiment, the retrieved electronic capture-and-display medium may include a series of views of a corresponding room. The series of views collectively provide a substantially panoramic view of the room.

The electronic plan may include one or more selectable icons. When one of the selectable icons is hyperlinked to a electronic capture-and-display medium, the icon may include a directional indicator of a direction of an initial point of view of the electronic capture-and-display medium. The electronic plan may include a legend of the icons. At least one of the selectable icons may correspond to a hazardous substance. The hazardous substance may include a poison, a corrosive substance, a volatile substance or a radioactive substance. One of the selectable icons may be hyperlinked to, for example, a list of contacts, an emergency plan, or another textual description.

The electronic plan, according to one embodiment, includes a plurality of electronic floorplans corresponding to respective floors of the facility. Each electronic floorplan may include links to the other electronic floorplans.

The displayed electronic capture-and-display medium may show an icon near, or superimposed on, a point of interest, to highlight the point of interest. When the icon is selected, a focused and/or enlarged view of the point of interest is displayed.

The point of particular interest may include a hazard or hazardous substance. The focused view may be supplemented with a description of preventive measures for the hazard or hazardous substance, a methodology for handling or treating the hazard or hazardous substance, and/or dangers posed by the hazard or hazardous substance.

The point of particular interest may include a vital system, such as gas, electric, ventilation, lighting, alarms, etc., or a control for the vital system. For example, the point of particular interest may be a power source or a control for shutting off the power source, a power line, a fuel source or a control for shutting off a fuel source, a fuel line, etc. The point of particular interest also may be a control for lights, a door hinge, a doorway or a glass window. The focused view may be supplemented with a description of a physical specification or operational specification of the vital system.

According to one embodiment, the apparatus may further include a media viewer integrated in a dual-functionality browser, wherein the electronic plan is shown in one portion of the browser and the retrieved electronic capture-and-display medium is shown in the media viewer portion of the browser. The retrieved electronic capture-and-display medium may include a corresponding audio track.

The subject application also provides method for providing a tool for emergency planning and management of a facility. According to one embodiment, the method includes (i) providing an electronic plan of the facility, wherein a plurality of hyperlinks are integrated with the electronic plan, the hyperlinks are associated with respective electronic capture-and-display media, and the electronic capture-and-display media provide visual representations of respective locations at the facility, (ii) retrieving one of the electronic capture-and-display media, after one of the hyperlinks corresponding to the retrieved electronic capture-and-display medium is selected, and (iii) playing the retrieved electronic capture-and-display medium in a viewer. The retrieved electronic capture-and-display medium, when shown in the viewer, includes a focused view of a point of particular interest, from an expert point of view.

The subject application also provides a method of preparing for one or more emergencies at a facility. The method, according to one embodiment, includes (a) preparing a hazard vulnerability analysis of an emergency plan for the facility to identify shortfalls of the emergency plan, and updating the emergency plan by using the hazard vulnerability analysis, (b) preparing an interactive multimedia survey tool comprising a plurality of electronic capture-and-display media, an electronic plan of the facility, and a plurality of hyperlinks integrated with the electronic plan, wherein the hyperlinks are associated with respective ones of the electronic capture-and-display media, the electronic capture-and-display media provides visual representations of respective locations at the facility, and at least one of the electronic capture-and-display media includes a focused view of a point of particular interest, from an expert point of view based on the hazard vulnerability analysis, and (c) using the survey tool to train emergency personnel for a selected emergency at the facility.

The subject application also provides a system for emergency planning and management of a facility. The system includes a storage device and a user interface including a browser and a viewer. An electronic plan of the facility is stored in the storage device, and a plurality of hyperlinks are integrated with the electronic plan. The hyperlinks are associated with respective electronic capture-and-display media. The electronic capture-and-display media provide visual representations of respective locations at the facility. The user interface retrieves the electronic plan with the integrated hyperlinks from the storage device, displays the retrieved electronic plan through the browser, and retrieves a selected electronic capture-and-display medium, after one of the hyperlinks which is associated with the retrieved electronic capture-and-display medium is selected, and plays the retrieved medium in the viewer. The retrieved electronic capture-and-display medium, when shown in the viewer, includes a focused view of a point of particular interest, from an expert point of view.

### BRIEF DESCRIPTION OF THE DRAWINGS

The above and numerous other objectives, features and advantages that may be achieved by the subject matter of the present disclosure will be more readily understood from the following detailed description by referring to the accompanying drawings wherein:

FIG. 1 shows a flow chart of a method, according to one embodiment, for preparing for one or more emergencies at a facility;

FIG. 2 shows a block diagram of an apparatus, in accordance with one embodiment, for emergency planning and management of a facility;

FIG. 3 shows a flow chart of a method, according to one embodiment, for providing a tool for emergency planning and management of a facility;

FIG. 4 shows a block diagram of a system, according to one embodiment, for emergency planning and management of a facility;

FIG. 5 shows a schematic view of an electronic plan, according to one embodiment;

FIG. 6 shows a schematic view of an electronic plan, according to another embodiment;

FIG. 7A shows a block diagram of an apparatus, in accordance with another embodiment, for emergency planning and management of a facility;

FIG. 7B shows a schematic view of a top-level of a multi-level electronic plan, according to one exemplary embodiment; and

FIG. 7C shows a schematic view of a dual-functionality browser window, according to one exemplary embodiment.

### DETAILED DESCRIPTION

This disclosure provides tools (in the form of, for example, apparatus, systems and methodologies) for emergency planning and management of a facility which include presenting, preferably, high-quality visual information through electronic capture-and-display techniques and with high interactivity. Accurate, easy-to-use facility information presented from an expert point-of-view contributes substantially to effective coordination and successful planning, consequence and crisis management. Information vitally needed by emergency personnel is centralized and made highly accessible to a user by collecting, coordinating and storing the information in electronic media. The collection of information is presented in a user-friendly format, such as described below, by using an electronic plan of the facility with plural hyperlinks integrated with the plan to access electronic capture-and-display media.

The terms “electronic capture-and-display medium” and “electronic capture-and-display media” are used herein to denote medium/media, such as video or non-video images, that are used to capture and display interactive visual information, from an expert point of view. For example, the electronic capture-and-display medium may include a series of views of a room which collectively provide an appearance of motion, as if the user were walking, or otherwise moving, through the room. In addition, the electronic capture-and-display media may optionally include associated audio tracks which provide aural information to supplement the visual information provided by the media.

The term “expert” as used herein refers to the typical emergency responder professional. Thus, the term “expert point-of-view” as used herein refers to the types of information that emergency responder professionals may consider important in order to assess a crisis or emergency. It should be noted that the tools described in this disclosure need not (unless specifically and expressly stated otherwise herein) be prepared, compiled or designed by emergency responder professionals. Instead, for example, an expert might specify broad criteria for, or categories of, points of interest, applicable to facilities generally. As another example, an expert might actually conduct one or more on-site inspections of a facility to identify specific points of interest at the location. Preferably, feedback from the expert is incorporated in the emergency planning and management tools, in order to present information from an expert point of view, as much as possible.

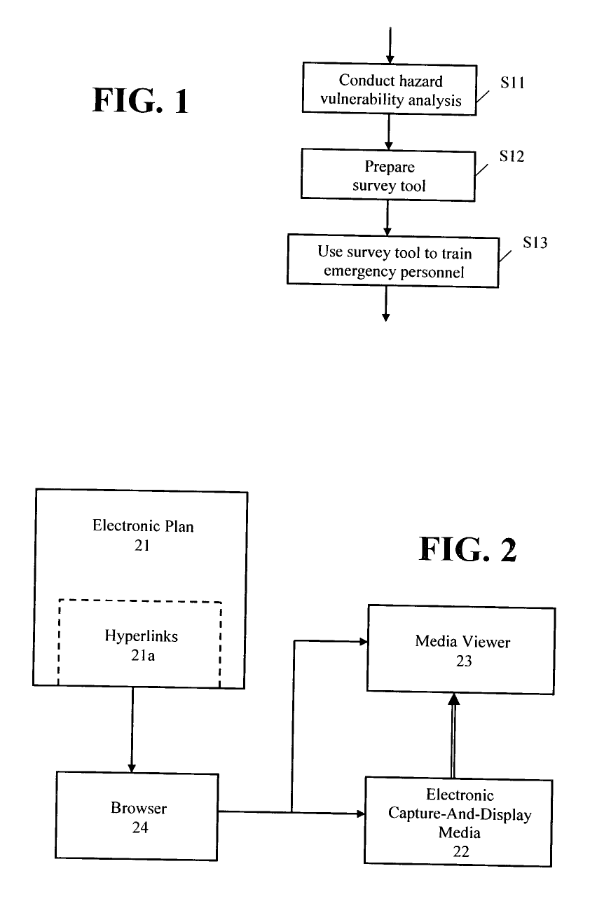

For example, a multi-tiered approach (FIG. 1) towards development of an emergency plan for a facility may be adopted, including, for example, analysis, planning, and training/exercise components. The multi-tiered technique may be used to identify areas of vulnerability and reduce risks to personnel, equipment and the facility, through development of strategic initiatives.

A hazard vulnerability analysis may be conducted as an initial step (step S11). The analysis may include a walk-through of the facility. The analysis and review of existing emergency plans form a basis for eliminating shortfalls identified, and serve as the basis for an updated emergency plan, a survey tool and/or updates to the tool.

A survey tool may be developed (step S12) for emergency planning and management of the facility based on walking through (and around) and analyzing the facility from an expert point of view. The survey tool may include a browser-based presentation of an electronic plan, which is integrated with hyperlink technology, of a selected facility. In a preferred embodiment (discussed below), the survey tool is interactive and multi-media.

In a training/exercise phase (step S13) using the updated emergency plan and the survey tool, basic awareness and comprehensive emergency management plan are developed. Training and exercises at the facility may focus upon, for example, the incident command system, hazardous materials, weapons of mass destruction, as well as all natural and technological hazards. Tests of the updated emergency plan are accomplished through exercises, developed in conjunction with preset goals and objectives, such as preservation of life, limb and property, and continuity of operations. Thus, in the example of a school facility, students, teachers and staff can be prepared for, in order to minimize, the dangers in the event of an emergency. Similarly, in a corporate context, analysis, planning and training provide confidence of safe and effective crisis resolution, and minimize risk of corporate liability.

The subject matter of this disclosure may be practiced with or without hazard vulnerability analysis and a training/exercise phase. However, in any event, the vital information is presented from an expert point of view.

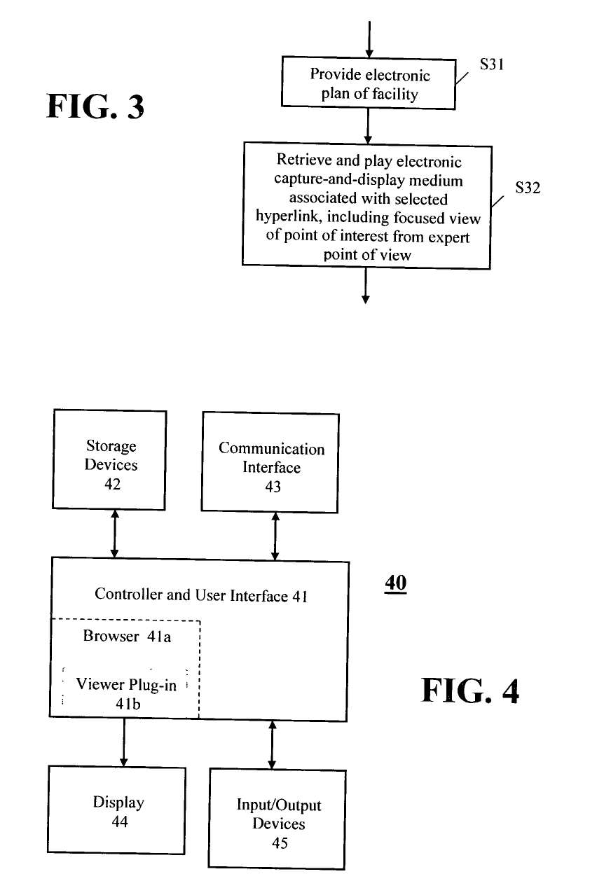

A block diagram for a survey tool, according to an exemplary embodiment, is shown in FIG. 2. Apparatus 20 includes an electronic plan 21 with integrated hyperlinks 21a, electronic capture-and-display media 22, and optional media viewer 23 and browser 24. Apparatus 20 may include one or more computer programs stored on a computer readable medium and/or transmitted via a computer network and/or other transmission media in one or more segments. The media viewer 23 and browser 24 may be provided as components of apparatus 20 or as separate add-ons, or may already reside on the platform on which the apparatus is installed.

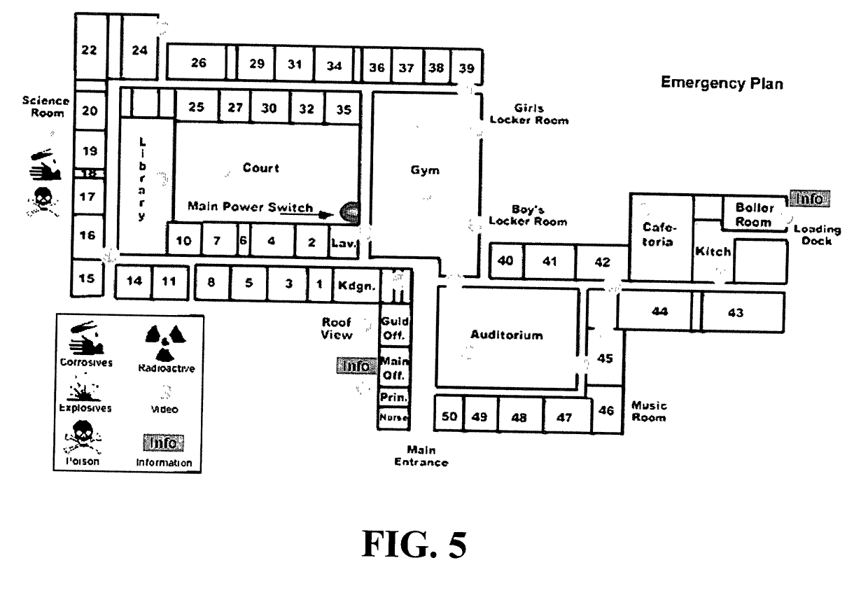

A method for providing a tool for emergency planning and management of a facility, in accordance with one exemplary embodiment, will be described with reference to FIGS. 2 and 3. The electronic plan 21 of the facility is provided and displayed through the browser 24 (step S31). The hyperlinks 21a are associated with respective ones of the electronic capture-and-display media 22 which correspond to respective locations at (and near) the facility. After a hyperlink in the electronic plan 21 is selected, one of the electronic capture-and-display media 22 which is associated with the selected hyperlink is retrieved and played in media viewer 23 (step S32). The retrieved electronic capture-and-display medium corresponding to a location at the facility, when played through the viewer, includes a focused view of a point of particular interest, from an expert point of view.

An electronic plan, according to one embodiment, provides a detailed map or schematic of a floor plan of the facility. Labels, such as room numbers and/or functions, and icons may be provided on the electronic plan, and associated with corresponding embedded hyperlinks. For example, some icons and/or labels may be associated with hyperlinks to electronic capture-and-display media of corresponding rooms, hallways, a rooftop, or other locations at or near the facility. In addition, icons may provide links to other highly relevant facility information (for example, contact numbers, hazards, controls, shutoffs and other components of vital systems such as gas, electric, ventilation, lighting, alarms, etc.), in order to provide a comprehensive and interactive information source. The electronic plan provides a high-level view of the facility from an expert point of view.

If a label (on the electronic plan) associated with a room in the facility is selected, the hyperlink associated with the label is activated and an electronic capture-and display medium corresponding to the associated room is retrieved and displayed through the media viewer. Visual information of the room, when displayed through the viewer, provides a user with a walk-through experience with regards to points of interest, without the user ever having been in the room. The points of interest may include, for example, entrance/egress, gas lines and shutoffs, boilers, electrical and HVAC (Heating, Ventilation, and Air Conditioning) systems, alarm and lighting controls, and dangerous substances, such as corrosive or radioactive material.

According to one embodiment, the displayed medium may be a motion video which provides a focused view of one or more points of particular interest in the corresponding room. In addition (or as an alternative) to motion videos, a series of individual shots and/or a substantially panoramic shot may be included in the electronic capture-and-display medium. In any event, the electronic capture-and-display medium, when shown in the media viewer, provides an appearance of motion (such as a virtual walk-through and/or 360° view of the room) and one or more focused views of points of interest from an expert point of view.

The user can interactively select what is shown, including vital data such as an emergency contact list or newly-downloaded details of victims inside the facility. By presenting the information from an expert point of view and in a manner and form that is easy to access and use, emergency responders can review critical facility information and coordinate tactical actions during an emergency, as well as selectively and quickly learn the points of interest in a selected room while obtaining a sense of orientation of the room and points of interest therein. Thus, responders can quickly obtain a realistic understanding of, and familiarity with, the facility and hazards therein, from an expert perspective, en route to and/or before entering the facility.

The displayed media depict information crucial to fire and law enforcement personnel and other first responders, to effect successful response to an emergency incident, in a wide variety of scenarios. For example, fire fighters normally operate under limited visibility conditions when performing fire suppression operations. The electronic plan and electronic capture-and-display media allow the firefighter to experience entry of and navigation through the facility under conditions of clear visibility, and map out an efficient route to effect a response prior to entering the facility in limited visibility circumstance.

In addition, the displayed media may show focused views of points of particular interest, such as actual/potential hazards, in a selected room. Also, the displayed medium may be supplemented by relevant textual description of the points of interest, such as a plan for avoiding or treating a hazard (for example, a combustible substance) or a physical/operational specification of a physical structure (for example, a boiler). A query function also may be provided, in order that the user can quickly locate relevant text by conducting a full-text search of the information base. Thus, the collection of information made available to a user provides the user with a virtual expert point of view of the facility, including identification of hazards at the facility, before the user enters the facility.

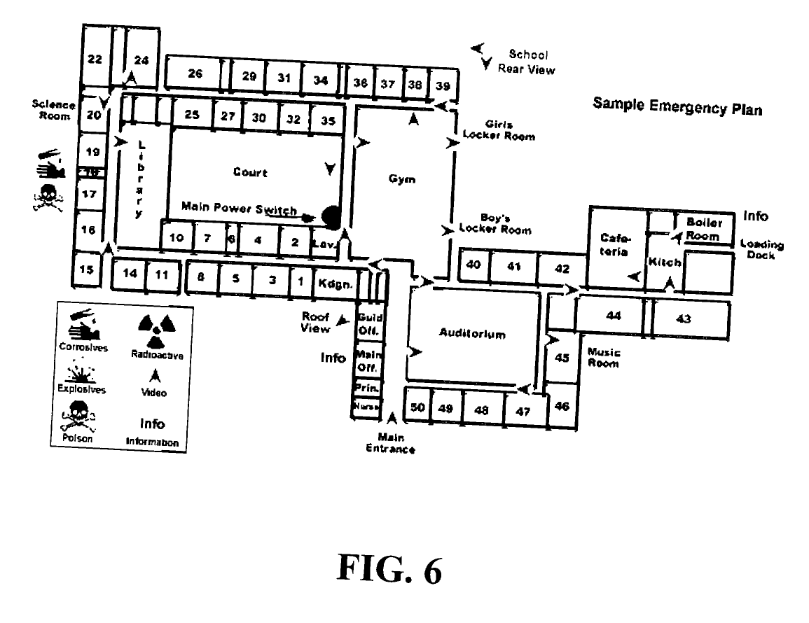

A system for emergency planning and management of a facility, according to one embodiment of the present disclosure, will be described with reference to FIG. 4.

System 40 may comprise controller and user interface 41 including optional browser 41a and media viewer 41b, storage devices 42, communication interface 43, display 44 and input/output devices 45.

The system may operate standalone or through one or more wired or wireless networks. In a networked system, communication interface 43 may include interfaces for communicating electronically with one or more other terminals or information sources through telecommunicative or computer networks. Such networks may include the Internet, an intranet, an extranet, a LAN (local area network), a WAN (wide area network), a wireless network, a satellite network and other networks. For example, assorted emergency planning information may be downloaded through the networks from a remote centralized database. Communication interface 43 includes the appropriate conventional units for interfacing with these networks, including, for example, Ethernet card, modem, wireless modem, etc. Interfaces for such communication are well known. Therefore, the communication interface is not described in detail here.

Storage devices 42 may be one or a combination of buffers, registers and memories [for example, read-only memory (ROM), programmable ROM (PROM), erasable PROM (EPROM), electrically erasable PROM (EEPROM), non-volatile random access memory (NOVRAM), etc.]. Other storage devices may include, for example, floppy disk drive, CD (or DVD) drive, hard disk, etc. The storage devices store code and data for controller and user interface 41.

Controller 41 coupled with assorted software components, control system operations and functionalities. As shown, for example, in FIG. 4, controller 41 may be connected to each of the other components in the system. Controller 41 may be a suitably programmed microprocessor or microcontroller, an application specific integrated circuit (ASIC), a programmable logic device, or, as one skilled in the art would understand and appreciate, a collection of discrete components suitably laid out and connected on a printed circuit board.

The software components include a graphical user interface, hardware management functions, and interfaces to other application software packages. The software components also include assorted device drivers, including a wireless communication driver if a wireless interface is provided. Thus, the subject matter of this disclosure may be integrated with other electronic tools which emergency responders may use, such as law enforcement (and other) databases.

The software components may be installed/stored in the storage devices 42, and/or received through the communication interface 43 via a network, such as the Internet, and/or a wireless transmission medium. Further, each software component may comprise one or more segments, subsets of which may be retrieved as need arises, from the storage devices 42 or from an external source via the network or transmission medium through the communication interface 43.

For example, the browser 41a and the viewer 41b each may be installed/stored in one or more of the storage devices 42, and/or downloaded through the communication interface via the network, as needed. Similarly, the electronic facility plan may be stored in one of the storage devices and/or downloaded via the network, as needed. Further, the browser and the viewer may be independent functional units (FIG. 2) or the viewer may be a plug-in to the browser (FIG. 4).

The system may receive, store and process textual, graphics, video and audio (as well as multimedia) information/data from various sources, such as a computer server, Web server, hand-held device server, in-vehicle navigation server, a satellite communication server and other internet servers. For example, the motion videos described above may be received, in accordance with one embodiment, through the communication interface as a (compressed or uncompressed) video stream from one of these servers. The motion videos may, of course, be stored in one of the storage devices, such as a DVD.

The input devices 45 may include keyboard, keypad, mouse, track ball, stylus, microphone, touchpad, touchscreen, etc., plus the appropriate device drivers. Also, a speaker, a printer, as well as other output devices may be included.

A user can quickly access selected information through the electronic plan coupled with use of, for example, a conventional pointing device [such as mouse, trackball, stylus, touchpad, touchscreen display, etc.]. The user preferably is provided with means for point-and-click access to selected information. For example, the user can click on, to select, a region of the electronic plan. Selection of the region activates a hyperlink corresponding to the selected region which causes display of a motion video, or another electronic capture-and-display medium, of a location (for example, a room, hallway, roof top, etc.) at (or near) the facility corresponding to the selected region.

The user may be provided with other means for selecting graphical (or pseudo-graphical, e.g., graphics combined with text) objects on the electronic plan. For example, alternative conventional means, such as directional arrow (←, ↑, ↓, →) keys and <TAB> and <SPACE> keys, for navigating across a display screen may be used.

As another example, a voice interface may be provided along with a microphone. Spoken words are picked up through the microphone and converted by applying speech recognition (software and/or hardware) technology. For example, a user, with visual prompt provided on the electronic plan, such as in the form of text and/or graphics, may give the oral command “LIBRARY”, which is then converted through speech recognition and triggers selection of the hyperlink associated with an electronic capture-and-display medium corresponding to the library at the facility.

The functionalities of the system may depend on the hardware and software implementation (for example, buttons and other actuators, as opposed to, or in combination with, graphical means on a touchscreen display). The functionalities may be combined/split or otherwise modified to ease the design, manufacture and serviceability of the system. Thus, functions may be implemented by, for example, a combination of software and hardware components. For example, the functionalities of the browser and viewer may be provided through the user interface coupled with the display.

The system may optionally include a position locator device, such as a global positioning system (GPS; or another satellite positioning system) receiver, other devices using a triangulation technique, etc. For example, in one embodiment in which a position locator device actively feeds current position information, the position locator device may be integrated with a portable, wireless unit which emergency responders can carry with them as they navigate through the facility. The portable unit has a suitable display (preferably, headgear). As the emergency responder walks-through a facility, the appropriate electronic capture-and-display medium is selected based on the current position information supplied by the position locator device. The selected electronic capture-and-display medium is retrieved and displayed. The position locator device may have a look-ahead feature, such that not only an electronic capture-and-display medium corresponding to a current position is made locally available, but also electronic media corresponding to one or more projected future positions are retrieved (as determined from, for example, heading information which also may be provided by the position locator device).

Such position locator feature is particularly suitable when, as discussed above, the emergency responder must navigate through a facility with limited visibility.

In view of the environments and contexts in which the system will likely operate, each component in the system preferably can be used in outdoor and extreme environments.

One exemplary embodiment of the subject matter of the present disclosure is contained in the computer program listing submitted on a compact disc as an appendix to provisional application No. 60/299,965. The submitted compact disc provides an interactive multi-media survey tool which includes an electronic plan of an exemplary (school) facility, a number of motion videos, and a number of textual descriptions, presented from an expert point of view.

The electronic plan “program” on the submitted compact disc is a hypertext file (coded in HTML, i.e. HyperText Markup Language). However, it should be apparent that other markup languages (for example, XML, etc.) and programming languages (for example, JAVA, Visual Basic, C++, etc.) may be used as well.

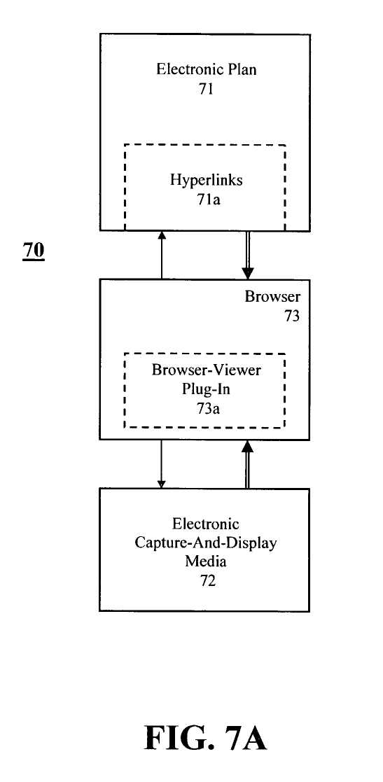

When the hypertext file is activated, the file is loaded into a browser program (for example, Internet Explorer), and a JPEG (Joint Photographic Experts Group) image of the electronic plan is retrieved by the browser program and displayed through the browser. A grayscale version of the JPEG image of the electronic plan is provided as FIG. 5.

As discussed above, the electronic plan may include a combination of graphical information (for example, icons) and textual labels. Icons may be provided on the plan to highlight hazards, vital information and videos which may be selected to be displayed. A legend may be provided on the plan to explain the nature of the icons. For example, in the exemplary embodiment contained in the submitted compact disc, icons corresponding to video, corrosives, explosives, poison, radioactive substance, and other vital textual description, respectively, are shown in a legend provided in the bottom left corner of the plan.

In addition, the electronic plan has a number of hyperlinks embedded therein which are not visible when the electronic plan is displayed through the browser (and not shown in FIG. 5). Each hyperlink is associated with one of the motion videos or text files. When a hyperlink corresponding to a video is activated, the video is retrieved into a default media viewer which is installed into the browser as a plug-in. The viewer program may be, for example, Microsoft Media Player, Microsoft Active Movie, Apple QuickTime, RealNetwork RealPlayer, or another media viewer which allows the user to view MPEG (Moving Pictures Expert Group) and/or other video format files. Once the video starts playing in the viewer, it may be manually stopped, paused, reversed, fast forwarded, etc.

The electronic plan and videos are provided from an expert perspective. For example, in the exemplary embodiment contained in the submitted compact disc. A video hyperlinked to a video icon near the “Main Entrance” label at the bottom center portion of the electronic plan shows the main entrance to the school, followed by a walk through a hallway inside the school and near the main entrance. The video provides vital information to responders for deciding whether entering the school through the main entrance is a viable option under the relevant circumstances, and, if the option is selected, what to expect upon entering the school through the path.

As another example, a hyperlink associated with a video icon (i.e. a dot in FIG. 5) under the “Science Room” label on the left side of the electronic plan, when selected, causes a video of the Science Room to be retrieved into the viewer. The video of the Science Room includes a sweeping view of the room and focused (and perhaps enlarged) views of points of particular interest. The sweeping view allows the user to obtain a substantially panoramic perspective of the room and the focused views identify points of particular interest, similar to what an emergency responder would want and need to see, from an expert point of view to become acquainted with the layout and relative positioning of objects in the room.

The focused views shown in the videos emphasize to the user selected points of particular interest, such as potential hazards. For example, the videos may show focused views of fuel/power conduits, fuel/power sources, controls for the sources, other controls (such as for a trash compactor or disposal unit), and chemicals and other hazardous substances. The hazardous substances might include poisons, corrosive substances, volatile substances, radioactive substances, and other substances that might present a risk to life and limb to the emergency responder entering the room in the event of an emergency. The focused view preferably provides sufficient detail for the user to identify and inspect the hazardous substance or object and obtain other vital information regarding the substance or object.

For example, the Science Room video shows a focused view of a gasjet which, from an expert perspective, should be highlighted as a hazard. Further, the video shows the contents of a chemical locker, including a focused view which enables the user to read the text on the bottles to identify the substances in the bottles. The video may also identify the location of first-aid kits in the room. In the case of hazardous substance, the video may be supplemented with a segment demonstrating appropriate medical treatment.

A video corresponding to the school library shows a sweeping view of the hallway outside the library, from an expert point of view, including a view of the library entrance, plus focus on glass windows adjacent to and in the door. Identification of glass windows, from an expert perspective, may be important to highlight the hazard of flying glass, possibility of alternate means of entry into and exit from the room, and likely visibility, to an intruder in the room, of law enforcement personnel in the hallway outside the room. In addition, views of doors should also include focused views of door hinges which provide important information, if the door needs to be knocked down.

As another example, a video corresponding to a panoramic view from the rooftop is also provided. The sweeping view from the rooftop is paused to show a door which is labeled “GYM ROOM ACCESS”. The existence and location of the door on the rooftop is vital information, from an expert point of view, because it is an entrance/egress for responders, as well as being a potential exit for intruders. A video of the rooftop may also show, for example, skylights, which can also be a means for entering the facility.

In addition, the video of a walk through the school boiler room provides close-up views of the shut-off controls in the boiler room, and the video of a walk through the school kitchen highlights hazards in the kitchen, such as stoves, ovens, water boilers, etc.

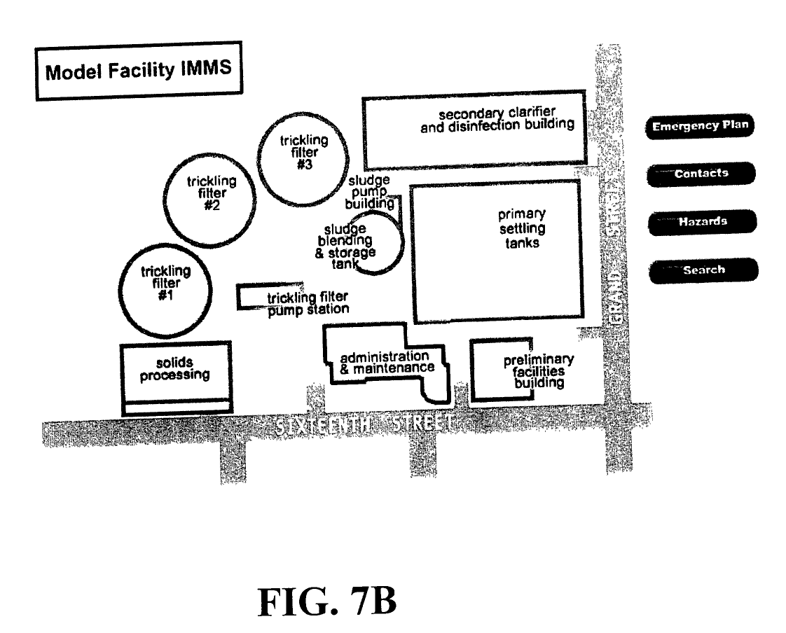

According to another embodiment (FIG. 6), video icons may include a directional indicator, such as an arrow. For example, a video icon of a panoramic view from a rooftop may indicate the direction of the initial point of view in the video. The video icon may be positioned on the electronic plan relative to the location in the facility of an initial point of view in the video. For example, a video icon corresponding to a video of a walk through a hallway may indicate the starting position of the walk-through and the direction of initial travel.

When a hyperlink corresponding to a textual description, which is in a corresponding hypertext file, is activated, the hypertext file is loaded in the browser program and causes another browser window to be spawned, displaying the textual description. For example, in the exemplary embodiment contained in the submitted compact disc, hyperlinks associated with icons corresponding to corrosives and poison, respectively, under the text “Science Room” are provided. When the icon (and moreover the associated hyperlink) associated with corrosive substances is selected, another browser window is spawned and a textual description of hydrochloric acid in the Science Room is retrieved into the spawned browser window. The description identifies the particular substance and provides other relevant information that an emergency responder might want to know regarding the substance, such as, for example, chemical and/or physical properties of the substance, hazards associated with the substance, potential health effects, and measures for first aid, fire fighting and/or otherwise handling the substance.

Textual descriptions also may be provided to make available, for example, contact information, an existing emergency plan for the facility, or physical specifications for a room or the facility. For example, an icon which includes the text “Info”, provided near the Main Entrance shown on the plan, corresponds to contact information for the facility. Another Info icon, which is provided next to the Boiler Room on the plan, corresponds to a description of boiler specifications. In addition, a hyperlink embedded near the top right corner of the plan corresponds to a textual description of an emergency plan for the facility.

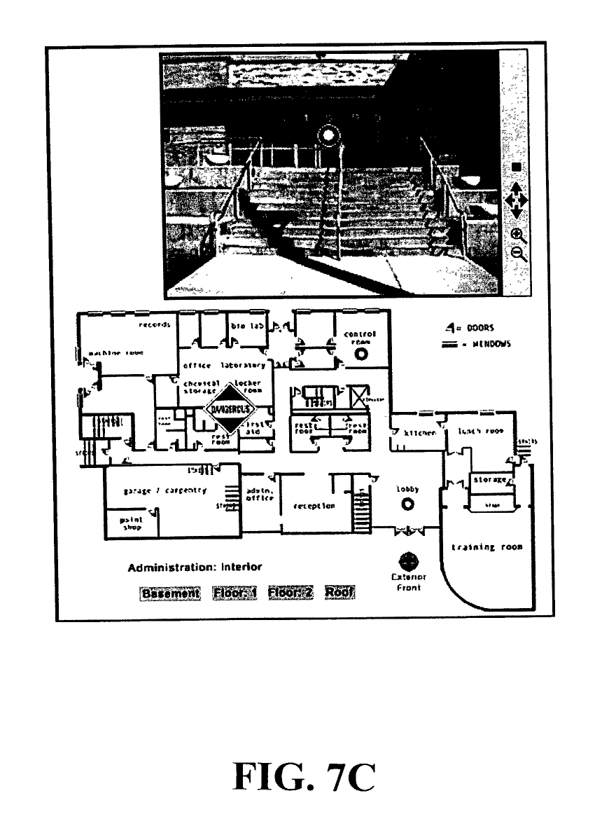

Another embodiment of an interactive multi-media survey (IMMS) tool will be described with reference to FIGS. 7A-7C. Apparatus 70 (FIG. 7A) includes an electronic plan 71, electronic capture-and-display media 72 and browser 73 with browser-viewer plug-in 73a.

The electronic plan 71 is multi-level. The top-level of the electronic plan (FIG. 7B) is an area map of a sanitation administration facility which is retrieved into and displayed in the browser 73. As shown in FIG. 7B, the facility includes a number of buildings and other structures, and is bordered on one side by Sixteenth Street and on another side by Grand Street.

The top-level of the electronic plan also includes buttons for retrieving a facility emergency plan, contact list, list of hazardous substances present in the facility, and a search tool, respectively, into a second browser window. Additional information may be retrieved by clicking on a link in the second browser window. For example, when the list of hazardous substances is retrieved and displayed in the second browser window, each item in the list may have a corresponding link to additional information describing the potential hazard(s) posed by the substance, preventive measures, and the appropriate methodology for handling or treating the hazard.

In addition, each building or structure in the facility is represented in the top-level of the electronic plan by a corresponding graphical object and label. When one of the graphical object and label in the top-level of the electronic plan is selected, another browser window is opened and a second-level of the electronic plan, corresponding to the selected building or structure, is retrieved into the newly opened window. The additional window, through the browser-viewer plug-in 73a, may provide dual functionality (i) for displaying electronic capture-and-display media and (ii) for displaying an electronic plan. For example, as shown in FIG. 7C, when the graphical object corresponding to the administration & maintenance building in the first browser window is selected, a dual-functionality window is opened and an electronic floorplan (of the first floor) of the administration & maintenance building is retrieved into one (bottom) portion of the dual-functionality window and an electronic capture-and-display medium showing an entrance to the administration & maintenance building is retrieved into another (top) portion of the dual-functionality window.

When an electronic floorplan is loaded into the dual-functionality window, the user can, at any moment, (a) click on any of the icons on the displayed floorplan or (b) click on one of the buttons provided below the displayed floorplan in order to select a floorplan of another floor in the building for display. Thus, a user can choose to view any arbitrary electronic capture-and-display medium provided by the survey tool for display.

In FIG. 7C, annulus icons indicate associated electronic capture-and-display media. It should be noted that, annulus media icons corresponding to only the control room and lobby are shown in FIG. 7C (for demonstrative purposes). Typically, most (if not all) rooms and areas in a building would have associated electronic capture-and-display media. In addition, other icons may be provided to highlight the presence of dangerous substances or objects, similar to the embodiments shown in FIGS. 5 and 6.

The electronic capture-and-display media 72 include panoramic images which provide sweeping 360° views from respective locations. The images are high quality and allow zoom-in without losing clarity with regard to relevant details which may provide vital information. The sweeping view provides a user with a walk through experience, which may be controlled by the user. The media viewer may provide stop and directional controls (pause, reverse and fast forward controls, which are not shown in FIG. 7C, also may be provided), as well as two modes of sweeping motion. In a first mode, the sweeping motion progresses automatically at a substantially constant rate, until the user operates one of the controls (or a 360° view is completed). In the second mode, the user manually controls the sweeping motion by, for example, (a) clicking in the image with a pointing device and dragging the cursor in a direction of desired motion (which may be towards the ceiling or floor), or (b) clicking an appropriate one of plural direction control indicators (for example, arrows) provided by the viewer.

In addition, the 360° panoramic images show an icon (for example, a bullseye symbol) at the location of a point of interest on the image, in order to highlight the presence of the point of interest. The icon pops up in the image near the point of interest as the point of interest comes into view in the image. The user can click on the icon to view additional information regarding the point of interest. When the user clicks on the icon, a new split-screen browser window is opened and a focused (and perhaps enlarged) view of the point of interest is displayed in one section of the new browser window. If the user then clicks on the focused view, additional textual description of the point of interest may be displayed in another section of the new browser window, to provide further information regarding the point of interest. For example, the description may be a relevant portion of the emergency plan. As another example, if the point of interest is a piece of equipment, the description may be a relevant portion of an operator's (or another) manual for the equipment.

Additional exemplary embodiments are described below.

A method for providing a tool for emergency planning and management of a facility includes, according to one embodiment, displaying an electronic plan of the facility, wherein a plurality of hyperlinks are integrated with the electronic plan. The hyperlinks correspond to respective electronic capture-and-display media, and the electronic capture-and-display media provide visual representations of respective rooms in the facility. The method further includes retrieving one of the electronic capture-and-display media, after one of the hyperlinks corresponding to the retrieved electronic capture-and-display medium is selected, and playing the retrieved electronic capture-and-display medium in a viewer. The retrieved electronic capture-and-display medium, when shown in the viewer, provides a focused view of a point of particular interest in a corresponding room and may provide an appearance of motion.

The method, according to another embodiment, includes providing an electronic plan of the facility, wherein a plurality of hyperlinks are integrated with the electronic plan, the hyperlinks correspond to respective electronic capture-and-display media, and the electronic capture-and-display media provide respective visual representations of selected rooms in the facility. The method further includes retrieving one of the electronic capture-and-display media, after one of the hyperlinks corresponding to the retrieved electronic capture-and-display medium is selected, and playing the retrieved electronic capture-and-display medium in a viewer. The retrieved electronic capture-and-display medium, when shown in the viewer, provides an appearance of motion and a focused view of a point of particular interest in a corresponding room.

The present disclosure also provides a method of preparing for one or more emergencies at a facility. According to one embodiment, the method includes preparing an interactive multimedia survey tool. The survey tool comprises a plurality of electronic capture-and-display media, an electronic plan of the facility, and a plurality of hyperlinks integrated with the electronic plan. The hyperlinks correspond to respective ones of the electronic capture-and-display media. The electronic capture-and-display media provide respective visual representations of selected rooms in the facility. At least one of the electronic capture-and-display media, when retrieved and shown in a viewer, provides an appearance of motion and a focused view of a point of particular interest in a corresponding room. The method further includes preparing a hazard vulnerability analysis of emergency plans for the facility to identify shortfalls of the emergency plans, updating the survey tool by using the hazard vulnerability analysis, and using the updated survey tool to train emergency personnel for a selected emergency at the facility.

An apparatus for emergency planning and management of a facility, according to one embodiment, includes an electronic plan of the facility and a plurality of electronic capture-and-display media. A plurality of hyperlinks are integrated with the electronic plan. The hyperlinks correspond to respective ones of the electronic capture-and-display media. The electronic capture-and-display media provide respective visual representations of selected rooms in the facility. At least one of the electronic capture-and-display media, when retrieved and shown in a viewer, provides an appearance of motion and a focused view of a point of particular interest in a corresponding room.

A system for emergency planning and management of a facility, according to one embodiment, includes a storage device and a user interface including a browser and a viewer. An electronic plan of the facility is stored in the storage device. A plurality of hyperlinks are integrated with the electronic plan. The hyperlinks correspond to respective electronic capture-and-display media. The electronic capture-and-display media provide respective visual representations of selected rooms in the facility. The user interface retrieves the electronic plan with the integrated hyperlinks from the storage device, displays the retrieved electronic plan through the browser, retrieves a selected electronic capture-and-display medium, after one of the hyperlinks corresponding to the retrieved electronic capture-and-display medium is selected, and plays the retrieved medium in the viewer. The retrieved electronic capture-and-display medium, when shown in the viewer, provides an appearance of motion and a focused view of a point of particular interest in a corresponding room.

The retrieved electronic capture-and-display medium, when shown in the viewer, may provide a panoramic view of a corresponding room. The retrieved electronic capture-and-display medium, as mentioned above, may include a series of views of a room, and the series of views collectively provide a substantially panoramic view of the room.

The retrieved electronic capture-and-display medium may include a motion video. The motion video, in accordance with one embodiment, may be pre-recorded, and, prior to recording, may have been produced by a camera in a walk-thru of a corresponding room. In another embodiment, when the hyperlink corresponding to the motion video is selected, the motion video is delivered to the viewer through a network as a video stream. In each of the embodiments, the motion video may include a panoramic view of a corresponding room.

The point of particular interest may include, but is not limited to, a hazard, a door hinge, a hazardous substance, a fuel source, a control for shutting off a fuel source, a fuel line, a power source, a control for shutting off a power source, a power line, a control for lights, and/or a boiler. The point of particular interest also may include a doorway, a rooftop, an entrance and/or an exit of the facility.

The electronic plan, in accordance with one embodiment, may be mapped in a grid system. The electronic plan may include one or more icons. The electronic plan may include a legend of the icons. At least one of the icons may correspond to a hazardous substance, such as a poison, a corrosive, a volatile substance, and/or a radioactive substance. At least one of the icons may have a link to a corresponding text file.

The electronic plan and the electronic capture-and-display media may be used for briefing emergency workers.

While some specific embodiments have been described in detail above, the description is not meant to be construed in a limiting sense. Various changes and modifications of the described embodiments could be effected by one skilled in the art without departing from the spirit or scope of the invention recited in the appended claims.

For example, the embodiment contained on the submitted compact disc is for a PC-type computer. It would be within the skill of one of ordinary skill in the art to adapt the embodiment for a Macintosh type computer, a PDA (Personal Digital Assistant), or another popular computing device.

Also, the embodiment uses a default browser already installed on the computing device. In other embodiments, a browser program may be provided on a compact disc or downloaded through a wired or wireless network. Similarly, the media viewer may be pre-installed, provided on a removable media, or downloaded from a network.

Further, although the description above refers to rooms in a facility, information regarding the regions in the immediate vicinity (but external to) the facility may be provided as well. For example, a motion video including a panoramic view of the area surrounding the facility may be provided.

In addition, although an exemplary embodiment of a school facility is described above, it should be understood that the subject matter of the present application may be adapted for other facilities, such as airports and other transportation terminals, government facilities, factories and other manufacturing plants, hotels, office and apartment buildings, malls and other shopping areas, etc.

Other improvements and modifications which become apparent to persons of ordinary skill in the art after reading this disclosure, the drawings and the appended claims are deemed within the spirit and scope of the present disclosure.

What is claimed is:

1. An apparatus for emergency planning and management of a facility, comprising:
an electronic plan of the facility, wherein a plurality of hyperlinks are integrated with the electronic plan; and
a plurality of electronic capture-and-display media,
wherein the hyperlinks are associated with respective ones of the electronic capture-and-display media, the electronic capture-and-display media provide visual representations of respective locations at the facility, and at least one of the electronic capture-and-display media, when retrieved and displayed, includes a focused view of a point of particular interest, from an expert point of view.

2. The apparatus claimed in claim 1, wherein the retrieved electronic capture-and-display medium includes a motion video.

3. The apparatus claimed in claim 2, wherein the motion video is pre-recorded.

4. The apparatus claimed in claim 3, wherein the pre-recorded motion video was produced by a camera in a walk-through of a corresponding room.

5. The apparatus claimed in claim 2, wherein, when the hyperlink corresponding to the motion video is selected, the motion video is delivered to a media viewer through a network as a video stream.

6. The apparatus claimed in claim 2, wherein the motion video includes a panoramic view of a corresponding room.

7. The apparatus claimed in claim 1, wherein the electronic plan includes one or more selectable icons.

8. The apparatus claimed in claim 7, wherein one of the selectable icons is hyperlinked to a electronic capture-and-display medium, and the icon includes a directional indicator of a direction of an initial point of view of the electronic capture-and-display medium.

9. The apparatus claimed in claim 7, wherein the electronic plan includes a legend of the icons.

10. The apparatus claimed in claim 7, wherein at least one of the selectable icons corresponds to a hazardous substance.

11. The apparatus claimed in claim 9, wherein the hazardous substance includes a poison, a corrosive substance, a volatile substance or a radioactive substance.

12. The apparatus claimed in claim 7, wherein one of the selectable icons is hyperlinked to a list of contacts.

13. The apparatus claimed in claim 7, wherein one of the selectable icons is hyperlinked to an emergency plan.

14. The apparatus claimed in claim 1, wherein the electronic plan includes a plurality of electronic floorplans corresponding to respective floors of the facility.

15. The apparatus claimed in claim 14, wherein each electronic floorplan includes links to the other electronic floorplans.

16. The apparatus claimed in claim 1, wherein each electronic capture-and-display medium which is associated with a hyperlink in the electronic plan can be selected when the electronic plan is displayed.

17. The apparatus claimed in claim 1, wherein the point of particular interest includes a hazard.

18. The apparatus claimed in claim 17, wherein the focused view is supplemented with a description of preventive measures for the hazard.

19. The apparatus claimed in claim 17, wherein the focused view is supplemented with a description of a methodology for handling or treating the hazard.

20. The apparatus claimed in claim 17, wherein the focused view is supplemented with a description of dangers posed by the hazard.

21. The apparatus claimed in claim 17, wherein the point of particular interest includes a hazardous substance.

22. The apparatus claimed in claim 17, wherein the point of particular interest includes a vital system.

23. The apparatus claimed in claim 22, wherein the focused view is supplemented with a description of a physical specification of the vital system.

24. The apparatus claimed in claim 22, wherein the focused view is supplemented with a description of an operational specification of the vital system.

25. The apparatus claimed in claim 17, wherein the point of particular interest includes a control for a vital system.

26. The apparatus claimed in claim 17, wherein the point of particular interest includes a power source.

27. The apparatus claimed in claim 17, wherein the point of particular interest includes a control for shutting off a power source.

28. The apparatus claimed in claim 17, wherein the point of particular interest includes a power line.

29. The apparatus claimed in claim 17, wherein the point of particular interest includes a fuel source.

30. The apparatus claimed in claim 17, wherein the point of particular interest includes a control for shutting off a fuel source.

31. The apparatus claimed in claim 17, wherein the point of particular interest includes a fuel line.

32. The apparatus claimed in claim 17, wherein the point of particular interest includes a control for lights.

33. The apparatus claimed in claim 17, wherein the point of particular interest includes a door hinge.

34. The apparatus claimed in claim 17, wherein the point of particular interest includes a doorway.

35. The apparatus claimed in claim 17, wherein the point of particular interest includes a glass window.

36. The apparatus claimed in claim 1, wherein the retrieved electronic capture-and-display medium includes a series of views of a corresponding room, and the series of views collectively provide a substantially panoramic view of the room.

37. The apparatus claimed in claim 1, wherein the displayed electronic capture-and-display medium shows an icon near, or superimposed on, a point of interest, to highlight the point of interest.

38. The apparatus claimed in claim 37, wherein when the icon is selected, a focused and/or enlarged view of the point of interest is displayed.

39. The apparatus claimed in claim 1 further comprising a media viewer integrated in a dual-functionality browser, wherein the electronic plan is shown in one portion of the browser and the retrieved electronic capture-and-display medium is shown in the media viewer portion of the browser.

40. The apparatus claimed in claim 1, wherein the retrieved electronic capture-and-display medium includes a corresponding audio track.

41. The apparatus claimed in claim 1, wherein the retrieved electronic capture-and-display medium provides an appearance of a walk-through of a corresponding room.

42. The apparatus claimed in claim 1, wherein the electronic plan and the electronic capture-and-display media are presented from the expert point of view for briefing emergency workers.

43. A method for providing a tool for emergency planning and management of a facility, comprising:
providing an electronic plan of the facility, wherein a plurality of hyperlinks are integrated with the electronic plan, the hyperlinks are associated with respective electronic capture-and-display media, and the electronic capture-and-display media provide visual representations of respective locations at the facility;
retrieving one of the electronic capture-and-display media, after one of the hyperlinks corresponding to the retrieved electronic capture-and-display medium is selected; and
playing the retrieved electronic capture-and-display medium in a viewer,
wherein the retrieved electronic capture-and-display medium, when shown in the viewer, includes a focused view of a point of particular interest, from an expert point of view.

44. A program storage device readable by a machine, tangibly embodying a program of instructions executable by the machine to perform a method for emergency planning and management of a facility, the method comprising:
displaying an electronic plan of the facility, wherein a plurality of hyperlinks are integrated with the electronic plan, the hyperlinks are associated with respective electronic capture-and-display media, and the electronic capture-and-display media provide visual representations of respective locations at the facility;
retrieving one of the electronic capture-and-display media, after one of the hyperlinks corresponding to the retrieved electronic capture-and-display medium is selected; and
playing the retrieved electronic capture-and-display medium in a viewer,
wherein the electronic capture-and-display medium, when shown in the viewer, includes a focused view of a point of particular interest, from an expert point of view.

45. A computer data signal embodied in a transmission medium which embodies instructions executable by a computer to provide a tool for emergency planning and management of a facility, comprising:
a first segment corresponding to an electronic plan of the facility, wherein a plurality of hyperlinks are integrated with the electronic plan; and
a second segment including one or more of a plurality of electronic capture-and-display media,
wherein the hyperlinks are associated with respective ones of the electronic capture-and-display media, the electronic capture-and-display media provide visual representations of respective locations at the facility, and the one or more electronic capture-and-display media, when retrieved and displayed, includes a focused view of a point of particular interest, from an expert point of view.

46. A system for emergency planning and management of a facility, comprising:
a storage device, wherein an electronic plan of the facility is stored in the storage device, a plurality of hyperlinks are integrated with the electronic plan, the hyperlinks are associated with respective electronic capture-and-display media, and the electronic capture-and-display media provide visual representations of respective locations at the facility; and
a user interface including a browser and a viewer,
wherein the user interface retrieves the electronic plan with the integrated hyperlinks from the storage device, displays the retrieved electronic plan through the browser, and retrieves a selected electronic capture-and-display medium, after one of the hyperlinks which is associated with the retrieved electronic capture-and-display medium is selected, and plays the retrieved medium in the viewer, the retrieved electronic capture-and-display medium, when shown in the viewer, including a focused view of a point of particular interest, from an expert point of view.

47. A method of preparing for one or more emergencies at a facility, comprising:
preparing a hazard vulnerability analysis of an emergency plan for the facility to identify shortfalls of the emergency plan, and updating the emergency plan by using the hazard vulnerability analysis; and
preparing an interactive multimedia survey tool comprising a plurality of electronic capture-and-display media, an electronic plan of the facility, and a plurality of hyperlinks integrated with the electronic plan, wherein the hyperlinks are associated with respective ones of the electronic capture-and-display media, the electronic capture-and-display media provides visual representations of respective locations at the facility, and at least one of the electronic capture-and-display media includes a focused view of a point of particular interest, from an expert point of view based on the hazard vulnerability analysis;
using the survey tool to train emergency personnel for a selected emergency at the facility.
